(19) United States
(12) Patent Application Publication
(10) Pub. No.: US 2010/0260869 A1
(43) Pub. Date: Oct. 14, 2010

(54) Biocidal materials

(75) Inventors: Yury Gogotsi, Ivyland, PA (US); Richard F. Rest, Rosemont, PA (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Drexel University, Philadelphia, PA (US)

(21) Appl. No.: 11/504,846

(22) Filed: Aug. 15, 2006

Related U.S. Application Data
(60) Provisional application No. 60/708,134, filed on Aug. 15, 2005.

(51) Int. Cl. A01N 59/00; A01P 1/00

(52) U.S. Cl. 424/661

(57) ABSTRACT

Provided are materials that effectively kill pathogenic bacteria and other organisms. Also disclosed are methods that concern the use of materials having biocidal activity, and biocidal systems that incorporate such materials.

### CROSS REFERENCE TO RELATED APPLICATION

The present application claims priority under 35 U.S.C. §119(e) to U.S. Provisional patent application Ser. No. 60/708,134, filed Aug. 15, 2005, the contents of which are incorporated herein by reference.

### GOVERNMENT RIGHTS

Research leading to the disclosed invention was funded, in part, by the U.S. National Institutes of Health, Grant No. U54 AI57168. Accordingly, the United States Government may have rights in the invention described herein.

### FIELD OF THE INVENTION

Provided are materials that effectively kill pathogenic bacteria and other organisms. Also disclosed are methods that concern the use of materials having biocidal activity, and biocidal systems that incorporate such materials.

### BACKGROUND OF THE INVENTION

With the occurrence of the Sep. 11, 2001 terrorist attacks on the U.S., followed by the mass fear and deaths due to the almost simultaneous and purposeful release of Bacillus anthracis through the U.S. postal system, the world was shocked into a more urgent confrontation with bioterrorism. Thousands of individuals had to undergo preventive treatments, and the resulting cost of the response mounted to hundreds of millions of dollars. These events demonstrated the need for renewed efforts to develop new antimicrobial materials.

B. anthracis, the cause of anthrax, is a Gram positive bacterium that has two major morphologic forms: a vegetative, rapidly growing form and a dormant, non-dividing spore form. B. anthracis spores are resistant to environmental pressures such as ultra-violet radiation, extremes of temperature and drying, and can survive almost indefinitely. Spores are found ubiquitously in the soil globally, where they intermittently infect and cause disease in animals. Within animals the spores germinate, i.e., they turn into vegetative bacteria, which grow to enormous numbers in the blood producing toxins that rapidly kill the animals. When the animal dies, the vegetative bacteria are stressed, morph to their spore form in the soil, and the cycle continues. When diseased animals or their products, such as skins, come into close contact with humans (ranchers, shepherds, veterinarians, hunters), humans can become infected with the spores and can develop skin or inhalation anthrax. Inhalation anthrax is routinely lethal.

Chlorine was shown to kill B. anthracis in the 1950s. Brazis A R et al. Appl Microbiol. 1958; 6(5):328-342. Chlorine dioxide, ClO₂, is presently the most widely used chlorine-containing gaseous sanitizing agent. It kills Listeria, B. anthracis, Salmonella, E. coli and other bacteria. Du J et al. Food Microbiology 2002; 19:481-490. Whereas ClO₂ is 1,000 times more effective than any other method for eliminating food-borne pathogens, it is corrosive and may damage electronics, fabrics and other products. Methyl bromide has been suggested as an effective and less expensive treatment to eradicate spores from buildings, and like Cl₂, it can kill anthrax spores. Kolb R W & Schneiter R. J Bacteriol. 1950; 59(3):401-412. However, it is one of the gases that depletes the Earth's protective ozone layer, and its many uses will be eliminated in the near future.

Sodium hypochlorite, NaOCl, also known as bleach, has been used in the U.S. as an antimicrobial since the 1950s. Bleach is effective against a wide range of bacteria, fungi and viruses and is used for disinfection and sanitization of households, food processing plants, hospitals, animal facilities, etc. It is also used as a laundry additive for disinfecting fabrics and laundry water. Chlorine in the form of sodium dichloroisocyanurate (NaDCC), C₃N₃O₃Cl₂Na, has been used for years as a bactericidal agent. It can decrease the number of viable Bacillus subtilis or Bacillus cereus spores by more than 5 logs in five minutes at concentrations above 5,000 ppm available chlorine. Coates D. J. Hosp. Infect. 1996; 32:283. However, no comparable studies have been performed with B. anthracis. Recent tests of seven commercial anthrax-decontamination technologies on six different surfaces showed that none of the products were able completely to achieve decontamination of the surfaces used in the test. Huibers P (2002).

The use of B. anthracis spores in warfare, or their use as bioterrorism or biocrime agents, requires first responders and other emergency personnel to wear personal protective apparatus including protective filtration masks or hoods. These masks are filled with filtering materials that generally trap bacteria before they are inhaled. There presently remains a need for systems that are capable of the effective filtration and decontamination of B. anthracis for the protection of personnel as well as for the remediation of affected sites.

### SUMMARY OF THE INVENTION

To address the urgent, unmet need for improved materials and techniques that effect the remediation of contaminated air, liquid, and physical spaces, and that protect living subjects from contaminated matter, there are provided biocidal materials comprising a carbon having a plurality of pores, said pores having characteristic dimensions less than about 2 nm, the material further comprising from about 1 to about 70 weight percent chlorine.

Also disclosed are biocidal systems comprising a material comprising a carbon having a plurality of pores, said pores having characteristic dimensions less than about 2 nm, the material further comprising from about 1 to about 70 weight percent chlorine; and, a container for receiving said material.

Novel methods for killing organisms present in a fluid are also provided, comprising contacting said fluid with a material comprising a carbon having a plurality of pores, said pores having characteristic dimensions less than about 2 nm, the material further comprising from about 1 to about 70 weight percent chlorine.

In addition, there are provided methods of making a biocidal material comprising a carbon having a plurality of pores, said pores having characteristic dimensions less than about 2 nm, the material further comprising from about 1 to about 70 weight percent chlorine comprising chlorinating a carbide at or above about 200° C.

### BRIEF DESCRIPTION OF THE DRAWINGS

The summary, as well as the following detailed description, is further understood when read in conjunction with the appended figures. For the purpose of illustrating the invention, there are shown in the figures exemplary embodiments of the invention; however, the invention is not limited to the specific methods, compositions, characteristics, and devices disclosed.

FIG. 1 depicts EDS analyses of the chlorine content in exemplary biocidal materials: weight % of chlorine in biocidal materials prepared from TiC and Ti₃SiC₂ is plotted as a function of synthesis temperature (a), and the average pore size (b).

FIG. 2 illustrates, in part (a), chlorine content in biocidal material prepared from Ti₃SiC₂ as a function of exposure time to ambient air. Part (b) shows thermo-gravimetric analysis (TGA) curve and mass-spectroscopy results for biocidal material prepared from Ti₃SiC₂ heated in He at 10° C./min.

FIG. 3 shows percent viable (a) B. anthracis spores and (b) B. anthracis vegetative cells after 45 and 120 minutes incubation with TiC-derived biocidal material samples as a function of synthesis temperature.

FIG. 4 depicts chlorine content in SiC-derived biocidal material as a function of processing conditions.

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific products, methods, conditions or parameters described and/or shown herein, and that the terminology used herein is for the purpose of describing particular embodiments by way of example only and is not intended to be limiting of the claimed invention.

In the present disclosure the singular forms “a,” “an,” and “the” include the plural reference, and reference to a particular numerical value includes at least that particular value, unless the context clearly indicates otherwise. Thus, for example, a reference to “a carbide” is a reference to one or more of such carbides and equivalents thereof known to those skilled in the art, and so forth. When values are expressed as approximations, by use of the antecedent “about,” it will be understood that the particular value forms another embodiment. Where present, all ranges are inclusive and combinable.

In view of the ongoing threat of bioterrorism, as well as challenges presented by quotidian environmental contamination, government, industry, and private citizens are keenly interested in technical improvements in air and liquid filtration, as well as remediation of physical spaces such as homes, offices, and public areas. The disclosed products and methods represent improvements with useful applicability to a vast array of timely and pressing needs, ranging from protection of buildings and personnel against bioterrorism, to decontamination of affected sites, to filtration of air and liquids.

Provided are biocidal materials comprising a carbon having a plurality of pores, said pores having characteristic dimensions less than about 2 nm, the material further comprising from about 1 to about 70 weight percent chlorine. The present carbon materials contain active chlorine and thereby represent efficient biocidal materials for personal protective devices, site remediation systems, filtration appliances, and many other uses. While large pores can be produced and well-controlled in a variety of materials (see Joo S H et al. Nature 2001; 412:169-172), nanopores in the range of 2 nm and below are usually achieved only in carbons or zeolites. Carbons have a much larger surface area and pore volume compared to zeolites, and are presently a preferred material for sorption and gas storage applications.

Carbide-derived carbons (“CDCs”) are produced by the extraction of metals from carbides at elevated temperatures. Gogotsi Y et al. Nature Materials 2003; 2:591-594. Since the rigid metal carbide lattice is used as a template and the metal is extracted layer-by-layer, atomic level control resulting in pore size ‘tunability’ can be achieved and the carbon structure can be templated by the carbide structure and chlorination temperature. See id.; see also Dash R K et al. Microporous and Mesoporous Materials 2005; 86:50-57; Dash R K et al. Microporous and Mesoporous Materials 2004; 72:203-208; Hoffman E N et al. Chem. Mater. 2005; 17:2317-2322.; Dash R K et al. Titanium Carbide Derived Nanoporous Carbon for Energy-Related Applications. Carbon 2006 (in press). CDCs can be produced at temperatures in the range of from about 200 to about 1,200° C. as a powder, coating or membrane. Gogotsi Y G & Yoshimura M. Nature 1994; 367:628-630. However, never before have porous carbon materials, including CDCs, been produced to possess biocidal properties.

It has been discovered that in addition to a high specific surface area (up to 2,300 m²/g) capable of retaining high loadings of fine particles, materials produced from carbides can retain a large amount of chlorine to be used as a biocide. As demonstrated herein, this property can make such compositions and products, as well as methods involving the use of such compositions, highly useful in gas and liquid filters for the neutralization of biological agents, or for cleaning or decontaminating infected water supplies, among many other applications.

The carbides from which the inventive biocidal materials can be produced preferably comprise binary or ternary carbides, or any combination thereof. Exemplary preferred carbides include SiC, TiC, ZrC, B₄C, WC, CaC₂, Al₄C₃, or Ti₃SiC₂. Processing of the starting material carbides includes chlorination of carbides under elevated temperatures. The provided biocidal materials can therefore comprise a carbide reacted with chlorine at a temperature from about 200° C. to about 1200° C. In other embodiments, the biocidal materials can comprise a carbide reacted with chlorine at a temperature that is less than about 800° C., less than about 600° C., or less than about 400° C.

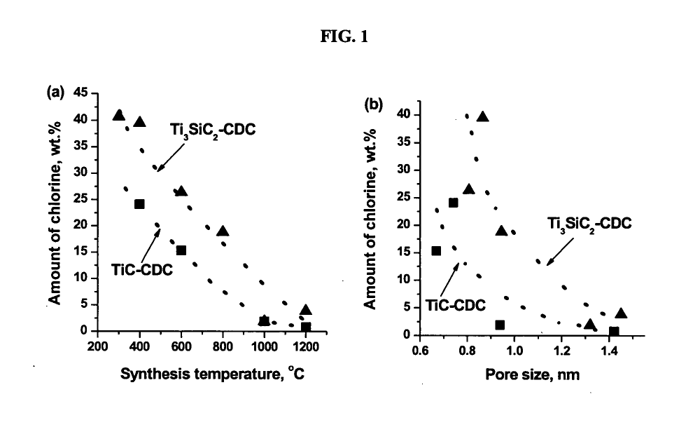

FIG. 1 provides an analysis using energy dispersive X-ray spectroscopy (“EDS”) to measure chlorine content (according to weight percent) in inventive biocidal materials produced under various temperature regimes. The weight percent of chlorine in carbons produced from TiC and Ti₃SiC₂ is shown as a function of synthesis temperature (a), and average pore size (b). These experimental results indicated that the weight percent of chlorine loaded into porous carbons varied inversely with chlorination temperature and pore size in the selected materials.

The weight percent of chlorine in the present biocidal materials can be tuned according to identity of preferred application. The inventive materials can be incorporated into gas filtration appliances, including those intended to ensure safe human respiration through the decontamination of ambient air. Biocidal materials comprising a high weight percent of chlorine can produce high chlorine gas emissions and an unpleasant odor, and biocidal materials including lower weight percent of chlorine can be chosen in order to diminish such characteristics. However, the properties of chlorine gas emission and strong odor are of modest concern with respect to liquid uses, and so biocidal materials having higher weight percent chlorine can be selected for such applications as water filtration. The present materials can possess a chlorine content that ranges from about 1 to about 70 weight percent. In other embodiments, the inventive materials comprise about 5 to about 70 weight percent chlorine, about 5 to about 60 weight percent chlorine, from about 10 to about 60 weight percent chlorine, or from about 30 to about 60 weight percent chlorine.

The inventive biocidal materials can be used for the provision of novel biocidal systems. Because they may incorporate any of the disclosed biocidal materials, such systems represent highly-effective tools for the decontamination of spaces, the purification of gas or liquid, the protection of personnel from harmful microbial agents, and other applications. Thus, there are also provided adsorption systems that include any of the inventive biocidal materials as previously disclosed, or any combination thereof, as well a container for receiving said material or combination of inventive materials. As used herein, “to receive” means to enclose, contain, suspend, fix into place, or otherwise accommodate the biocidal material. For example, a container can comprise a flexible or rigid cartridge. A container may also comprise fluid filtration units, which can include personal protection masks or portions thereof, liquid filtration devices such as water purification appliances, air filtration appliances for purification of building spaces, or any appliance that accommodates the biocidal material. A pouch made of any flexible or rigid material can also function as the container, such as are typically seen with regard to cotton pouch-enclosed or plastic cartridge-encased activated-carbon. A container can also take the form of a filter frame, whereby, for example, the biocidal material forms a membrane, screen, or flat sheet that is held in place by a support structure. The container can also be a suspension matrix that supports the biocidal material in space. Those skilled in the art will recognize the various means by which the biocidal material may be received within a container, and all such containment formats are contemplated as being within the scope of the present invention.

In their manufactured state, the present biocidal materials can comprise a substantially granular or particulate conformation, such as a powder. For some applications, it may be advantageous for the inventive materials to be available in a substantially non-particulate form, such as a form in which the individual material particles are bound to one another. In such a form, the biocidal material can be easily manipulated, and even molded into a desired configuration, for example, a cylinder for incorporation into a filtration apparatus. Accordingly the present biocidal materials may further comprise a binder that enables the adhesion of composition particles to one another. With respect to the instant biocidal systems, the container can comprise a binder. Such binders preferably comprise polymers, many types of which are readily identified by those skilled in the art, but may comprise any material that functions to join particles to one another and that does not substantially interfere with the biocidal activity of the disclosed materials. An exemplary binder polymer is teflon. When the instant materials are intended for use in applications that involve, for example, purification of water, personal protection devices, medical sterilization or sterilization of edible or potable substances, the selected binder is preferably compatible with such a use in terms of safety and efficacy and compatibility with human health requirements.

Also disclosed are highly effective methods for killing organisms present in a fluid. The provided methods comprise contacting a fluid in which organisms are present with any of the previously disclosed biocidal materials, or any combination thereof. The contacting of the fluid with the biocidal material may have a duration of or be longer than five, 30, or 60 minutes. Shorter contact times can also be effective in certain applications. Suitable as contact times are periods of about a second, 10 seconds, or a minute or two. The present methods employ the inventive materials and the biocidal characteristics by which they are uniquely identified to permit the neutralization of living organisms from fluids, and can therefore be advantageously used with broad array of human safety, fluid processing, or industrial applications. For example, the present methods may be employed for the purification and chlorination of contaminated drinking water; for sanitation of swimming pools; for protection against infected air during respiration; for remediation of infected buildings, dwellings, and other public spaces via air filtration; for sanitation during food processing; for disinfection of medical facilities and equipment; and, for many other critical purposes, each by contacting the infection-bearing fluid with any of the disclosed biocidal materials.

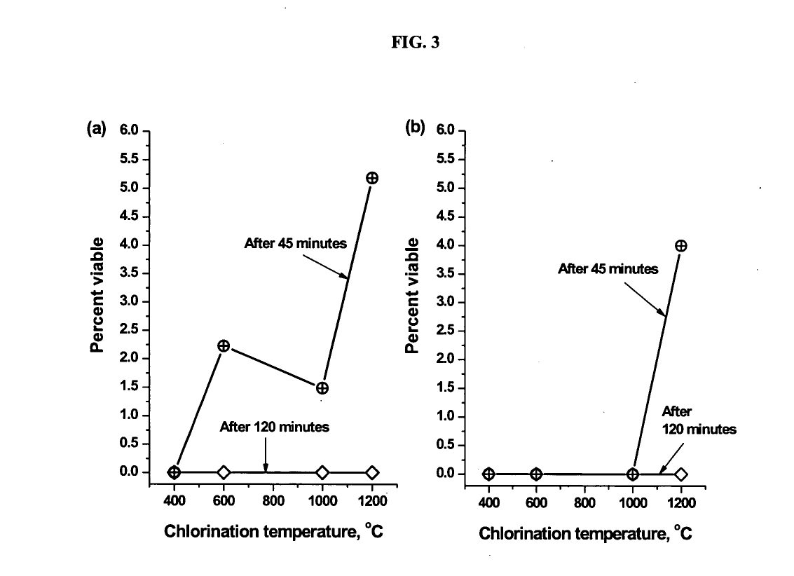

Bacteria represent an ideal target with respect to the instant methods, including both Bacillus anthracis and Escherichia coli. Example 3, infra, and FIG. 3(a) demonstrate that the inventive materials are effective for the killing of B. anthracis spores and vegetative cells. The materials, as well as the systems and methods disclosed herein, therefore represent a highly advantageous alternative to the costly and complex currently-existing means for the remediation of sites, in either air or liquid environments, that have been exposed to B. anthracis. The instant invention is also useful for the elimination of other organisms, including other bacterial species and strains, including those that are viewed as less pernicious but still undesired. All organisms whose death may be accomplished by exposure to chlorine are contemplated as being within the scope of the instant invention.

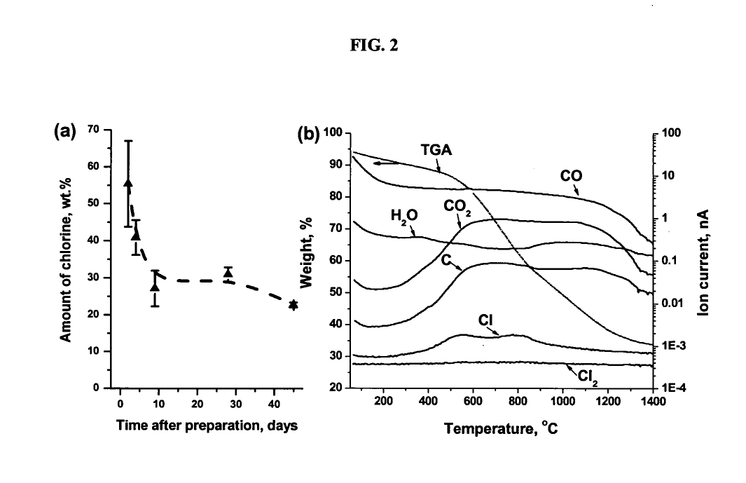

As disclosed in the ensuing examples, the release of trapped chlorine from the pores in the present materials is very slow. FIG. 2(a) illustrates how, with respect to storage in ambient air, after initial chlorine loss within the first week of storage, a slow loss occurs during the next 30 to 40 days, after which a substantial weight percent of biocidal chlorine still remains trapped within the pores. In one study, several attempts were made to remove chlorine from a sample biocidal material, including by incubation in water, incubating in cell culture media, sterilization in an autoclave, and boiling in dionized water. Surprisingly, the material retained biocidal activity after exposure to each of these processing conditions. In an additional series of studies, samples were stored in sealed glass containers for 2-3 years, after which time they still produced a strong smell of chlorine and retained chlorine content of the same order of magnitude as freshly synthesized material. When hermetically sealed, the shelf-life of biocidal materials should be virtually unlimited. Furthermore, material that had been in water for 1 week were still able to kill bacteria, as were material samples exposed to open air for more than a month (data not shown). Accordingly, chlorine in the instant biocidal materials, for use with the disclosed biocidal systems and methods, is persistently retained in a bioactive form and is not removed from the porous carbon structure, an unexpected finding in view of the fact that chlorine gas is otherwise known readily to react with water to form a mixture of soluble chlorine, hydrochloric acid, and hypochlorous acid. These results also demonstrate that the inventive materials, systems, and methods are effective for the killing of organisms in a gas or in a liquid environment.

Also disclosed are novel production methods that use carbides as starting materials. Disclosed are novel methods of making a biocidal material comprising a carbon having a plurality of pores, said pores having characteristic dimensions less than about 2 nm, the material further comprising from about 1 to about 70 weight percent chlorine comprising chlorinating a carbide at or above about 200° C. In some embodiments, the chlorination temperature is about 400° C. to about 1200° C. FIG. 1(a) provides a graphical depiction of weight percent of chlorine in TiC— and Ti₃SiC₂-derived biocidal material as a function of synthesis temperature. An inverse relationship between weight percent chlorine and synthesis temperature was discovered, and accordingly in some embodiments of the disclosed methods of making a biocidal material the temperature at which the chlorination of the carbide is about 400° C. to about 800° C. The chlorination period can be up to 2 hours, or can be 2 or more hours long. The disclosed methods of making a biocidal material can further comprise cooling said carbide in a purge of chlorine.

Carbide starting materials can comprise binary or ternary carbides. Exemplary binary and ternary carbides include SiC, TiC, ZrC, B₄C, WC, CaC₂, Al₄C₃, or Ti₃SiC₂, although other binary or ternary carbides can be selected. All suitable carbides and combinations of two or more suitable carbides are contemplated as being within the scope of the present invention.

The present methods, which can be practiced using any combination of the disclosed parameters, therefore permit the synthesis of specialized carbons. Biocidal materials produced according to the inventive methods are also within the scope of the instant invention.

The present invention is further defined in the Examples included herein. It should be understood that these examples, while indicating preferred embodiments of the invention, are given by way of illustration only, and should not be construed as limiting the appended claims From the present disclosure and these examples, one skilled in the art can ascertain the essential characteristics of this invention, and without departing from the spirit and scope thereof, can make various changes and modifications of the invention to adapt it to various usages and conditions.

### Example 1

### Preparation of Exemplary Biocidal Material

The experimental setup and structure and composition of carbide powders for synthesis of carbide-derived carbon have been described elsewhere. See Yushin G, Nikitin A, Gogotsi Y. Carbide Derived Carbon. In: Gogotsi Y, editor. Nanomaterials Handbook: CRC Press, at pp. 237-280 (2005). The method of carbide-derive carbon (CDC) preparation is a selective etching of carbides with gaseous chlorine at 200-1,200° C. In this study, CDC was prepared from titanium carbide (TiC), titanium-silicon carbide (Ti₃SiC₂), silicon carbide (SiC) and zirconium carbide (ZrC) powders. See Gogotsi Y G et al. J. Mater. Chem. 1997; 7(9):1841-1848; Gogotsi Y et al. Nature Materials 2003; 2:591-594; Dash R K et al. Microporous and Mesoporous Materials 2005; 86:50-57; Dash R K et al. Titanium Carbide Derived Nanoporous Carbon for Energy-Related Applications. Carbon 2006 (in press); Yushin G et al. Carbon 2005 44(10):2075-2082.

The starting material was placed into the quartz tube of a resistance furnace in a quartz boat. The furnace was then heated to the desired temperature (400-1,200° C.) under argon (Air Gas, UHP grade) purge. Once the desired reaction temperature was reached, chlorine gas (Air Gas, UHP grade) at 10-15 cm³/min was passed through the furnace for 3 hours. The reaction between carbide and chlorine has linear kinetics (Ersoy D A et al. Mat. Res. Innovat. 2001; 5:55-62) which allows transformations to a large depth, until the particle or component is completely converted to carbon. Chlorination in a flow of pure Cl₂ for 3 hours in a quartz tube furnace results in extraction of metals from carbides, leading to the formation of nanoporous carbon. After chlorination, samples were cooled in a purge of chlorine unless stated otherwise.

Selected CDC samples were dechlorinated by annealing in Ar or Ar—H₂ gas mixture at elevated temperatures (either at 800° C. or at the chlorination temperature). The effect of storage at ambient temperatures in laboratory air on chlorine content was also investigated. In addition, analysis of gas evolution upon heating selected CDC samples in helium at a heating rate of 10° C./min was conducted. A TA Instruments thermal balance with a quadrupole mass-spectrometer was employed in these studies.

### Example 2

### Measurement of Chlorine Content

The amount of chlorine in CDC was evaluated using energy dispersive X-ray spectroscopy (EDS). Coefficients of elemental sensitivity were used in calculations of chlorine content. While absolute values of elemental composition can be determined with the accuracy of one percent or less, EDS studies may provide underestimated values of trapped gases due to the exposure of samples to vacuum required for the analysis. However, for this work it was important to obtain comparative values that show the effect of the processing on the content of chlorine in CDC.

The mechanisms and kinetics of chlorination of carbons prepared from the carbides TiC (Dash R K et al. Titanium Carbide Derived Nanoporous Carbon for Energy-Related Applications. Carbon 2006 (in press)), ZrC (Dash R K et al. Microporous and Mesoporous Materials 2005; 86:50-57), SiC (Gogotsi Y G et al. J. Mater. Chem. 1997; 7(9):1841-48), and Ti₃SiC₂ (Gogotsi Y G et al. Nature Materials 2003; 2:591-594; Yushin G et al. Carbon 2005 44(10):2075-2082), as well as carbon microstructure, surface area and pore-size distribution have been described previously. In general, higher mobility of carbon atoms at higher synthesis temperatures results in more ordered structure and larger pore size in CDC. The present study revealed the connection between the amounts of chlorine retained in CDCs and the CDC synthesis temperature (FIG. 1a). The correlation between the average pore size and weight percent of retained chlorine was less straightforward (FIG. 1b). While smaller pores in general favored trapping of chlorine atoms, low synthesis temperature and correspondingly more disordered CDC structure (larger degree of dangling carbon bonds) was a more prominent factor in enhanced chlorine storage. According to EDS analysis the amount of chlorine retained in pores decreases by a factor of 20 or more (from ˜40 wt % to <2 wt % in Ti₃SiC₂-CDC and from ˜20 wt % to <1 wt % in TiC-CDC) when the synthesis temperature increased from 400 to 1,200° C. (FIG. 1a).

Preliminary experiments indicated that bonding of chlorine to the synthesized carbon composition is quite strong, and the release of the trapped chlorine at room temperature is very slow. After a relatively quick release in the first week of synthesis, chlorine content decreases only to ˜20 weight percent after storage for 45 days in open air (FIG. 2a); without being bound by any theory of operation, this results suggests that chlorine is physisorbed by carbon. Five different forms of chlorine fixed on carbon black have been reported in the literature; the most prevalent variety involves single Cl atoms bonded to carbon atoms, but there also occurs 11-16% of CCl₂ and CCl₃ groups. Small amounts of molecular Cl₂ and Cl₂⁻ ions have also been found. See Papirer E et al. Chlorination Carbon 1995; 33(1):63-72. Chlorine bound to carbon surfaces is chemically quite inert. It is not hydrolyzed by washing with dilute alkali, and only a small fraction passes into solution on treatment with boiling 2.5 N NaOH for several hours. Carbon surfaces with chemisorbed chlorine are hydrophobic.

Without being bound by any particular theory of operation, it appears that the instant carbons are hydrophilic and most of the chlorine may be trapped as Cl₂, with some being present as metal chloride inside pores or chemically bound to carbon. Release of atomic chlorine was observed upon heating in He (FIG. 2b) above 300° C., with the maximum release rate achieved at about 550° C. (chlorine trapped in pores) and then another maximum at 800° C. (chemically bound chlorine).

### Example 3

### Biocidal Activity

Two medically important bacteria were used: B. anthracis, a Gram positive, spore-forming biowarfare and bioterrorism agent and, E. coli, a Gram negative bacterium that is a common cause of gastroenteritis, neonatal meningitis, and urinary tract infections. B. anthracis Sterne strain 7702 and E. coli DH5α were grown in brain heart infusion (“BHI”) broth or Luria-Bertani (“LB”) broth, respectively, as previously described. Shannon J G et al. Infect Immun 2003; 71(6):3183-9. Spores were obtained by incubating B. anthracis in presence-absence (PA) broth at 30° C. for 3-4 days followed by washing, and heat treatment (65° C. for 30 min). See Dixon T C et al. Cell Microbiol 2000; 2(6):453-63.

The bactericidal activity of various carbon preparations was assayed as follows. CDC stock solutions were 100 mg/ml in sterile distilled water, and were sonicated for 15 minutes. Vegetative B. anthracis were obtained from overnight BHI broth growth, whereas E. coli were obtained from overnight LB broth growth, both at 37° C. with rotary shaking at 250 rpm. Overnight cultures were washed once in sterile distilled water (5,000×g, 10 min), and suspended to 1×10⁸ CFU/ml sterile distilled water or broth, as indicated in specific experiments. Time zero bacterial viability was determined from the appropriately diluted fresh washed stock suspension. For the bactericidal assays, to a 96 well flat bottom plate were added 50 μl of bacteria (appropriately diluted), a volume of CDC from the 100 mg/ml sonicated stock suspension to allow the proper final concentration, and water or bacteriologic broth to a final volume of 150 μl.

Plates were incubated at 37° C., with orbital shaking. At appropriate times, 30 μl from each well was spread onto LB plates, which were incubated 37° C. overnight in a humidified incubator. Colonies were counted the next day. Data are presented either as raw data, i.e., CFU, or as % viable, which was determined according to the formula [(CFU at the experimental time point)/(CFU at time 0)]×100.

Preliminary tests were conducted using SiC as a starting material, which after chlorination was cooled in a flow of Ar and contained ˜2-6 weight percent chlorine. There was no killing of B. anthracis spores by this composition, whether in suspension or when mixed with B. anthracis in a pellet for 1 hour. However, there was some killing of E. coli, suggesting that while the material was bactericidal, the chlorine concentration may have been insufficient to kill spores. When composition prepared from SiC (cooled in Cl₂) and having 20-55 weight percent chlorine was used, E. coli and B. anthracis spores and vegetative cells were readily killed. We also performed experiments where B. anthracis spores were mixed with composition and then deposited via vacuum filtration onto sterile filter paper disks. The disks were incubated at 37° C. for various times, and then the bacterial spores were resuspended in sterile bacteriologic medium and quantified by plating for CFU. In one representative experiment of this type, bacterial viability decreased by 95% in 120 minutes (data not shown). These results indicated that while dry composition possesses significant bactericidal activity, water (humidity) can assist to efficiently extract chlorine and accomplish complete killing. Therefore, all experiments reported hereafter were conducted in solutions.

To study the relationship between the amount of chlorine retained in prepared biocidal materials and the materials' antibacterial activity, samples of material prepared from TiC, synthesized at different temperatures and having different chlorine content, were incubated with B. anthracis spores (FIG. 3a) and vegetative cells (FIG. 3b) for 45 and 120 minutes, and subsequent bacterial viability was determined. At 45 minutes, samples synthesized at 400° C. and containing 25 weight percent chlorine killed 100% of spores (FIG. 3a). Samples containing lower amounts of chlorine (synthesized at 600° C., 1000° C., and 1200° C.) expressed decreased bactericidal activity against B. anthracis spores. When the incubation time was increased to 120 minutes, all inventive material samples, even those containing only 2 weight percent chlorine, killed all or most of B. anthracis spores. These experiments suggest that the amount of active chlorine released by the materials prepared from TiC carbide was sufficient to demonstrate bactericidal effect in all the samples, and longer exposure time of 120 min was required for the spore destruction. Not wishing to be bound by any particular theory of operation, it is proposed that either 1) the rate of the diffusion of active chlorine from the biocidal material to the spores, or 2) the rate of spore membrane disruption determined the overall kinetics of spore killing. Vegetative B. anthracis cells, which have much more sensitive membranes than spores, required less exposure time for the fatal disruption. In fact, even a short dosage time of 45 minutes was enough to successfully kill bacteria by all but one sample (FIG. 3b).

Not wishing to be bound by any particular theory of operation, it is proposed that active chlorine, released in a monatomic state from the instant materials, disrupts the cell wall to kill B. anthracis and other bacteria. Since chlorine is released upon direct contact in the active state, it tends to be more efficient compared to Cl₂ gas and is similar to chlorine radicals produced by decomposition of ClO₂. It may be that the continuous supply of chlorine from the carbon compositions is a factor that helps maintain the concentration of active chlorine sufficiently high for a prolonged period of time. Additional experiments on the disinfection of various suspensions of B. anthracis spores and vegetative cells, as well as E. coli by exposure to the instant materials (see Table 1, below) proved that the inventive materials, when obtained from various carbide precursors and synthesized at various conditions, are extremely efficient and effective materials for killing bacteria.

TABLE 1

| Incubation time (min) | | | | | |
|---|---|---|---|---|---|
| 45 | | 90 | | 120 | |
| Concentration of material in | | | | | |
| solution (mg/ml) | | | | | |
| 12.5 | 50 | 12.5 | 50 | 12.5 | 50 |

TiC-derived material prepared @400° C.

| | | | | | | |
|---|---|---|---|---|---|---|
| B. anthracis spores in BHI | 1 | 0 | 9 | 0 | — | — |
| B. anthracis spores in H₂O | 3 | 0 | 0 | 0 | — | — |
| B. anthracis spores in PBS | 156 | 1 | 59 | 7 | — | — |
| B. anthracis vegetative cells in BHI | 0 | 0 | 1 | 0 | — | — |
| E. coli vegetative cells in BHI | 800 | 0 | 736 | 0 | — | — |

ZrC-derived material prepared @400° C.

| | | | | | | |
|---|---|---|---|---|---|---|
| B. anthracis spores in BHI | 7 | 1 | 9 | 0 | — | — |
| B. anthracis spores in H₂O | 6 | 1 | 6 | 0 | — | — |
| B. anthracis spores in PBS | 96 | 1 | 53 | 1 | — | |
| B. anthracis vegetative cells in BHI | 0 | 0 | 0 | 0 | — | — |
| E. coli vegetative cells in BHI | 800 | 0 | 100 | 0 | — | — |

TiC-derived material prepared @1200° C.

| | | | | | | |
|---|---|---|---|---|---|---|
| B. anthracis spores in BHI | 20 (310) | 12 (310) | — | — | 9 (310) | 4 (310) |
| B. anthracis spores in PBSG | 25 (224) | 13 (224) | — | — | 15 (224) | 9 (224) |
| B. anthracis vegetative cells in BHI | 2 (420) | — | — | — | 1(420) | — |
| B. anthracis vegetative cells in PBSG | 6 (308) | — | — | — | 4 (308) | — |

SiC-derived material prepared @1200° C.

| | | | | | | |
|---|---|---|---|---|---|---|
| B. anthracis spores in BHI | 21 (310) | 12 (310) | — | — | 9 (310) | 7 (310) |
| B. anthracis spores in PBSG | 23 (224) | 12 (224) | — | — | 18 (224) | 6 (224) |
| B. anthracis vegetative cells in BHI | 1 (420) | — | — | — | 2 (420) | — |
| B. anthracis vegetative cells in PBSG | 15 (308) | — | — | — | 12 (308) | — |

In Table 1, values in parentheses represent the starting number of spores or vegetative cells at time zero. These data are from several experiments performed on different days, each repeated at least once. “BHI” refers to brain heart infusion broth, “PBS” refers to phosphate buffered saline, and “PBSG” refers to phosphate buffered saline with 0.1% (w/v) gelatin.

It was observed that killing of B. anthracis spores was equally efficient whether carried out in water or in rich bacteriologic medium (BHI), and that B. anthracis vegetative cells were more sensitive to, and were killed more quickly than were spores. B. anthracis vegetative cells were especially sensitive to the chlorine-loaded material, even more so than E. coli; as little as 12.5 mg/ml of material sterilized a suspension of 1×10⁶ B. anthracis spores in 45 minutes (see Table 1).

### Example 4

### Chlorine Reloading

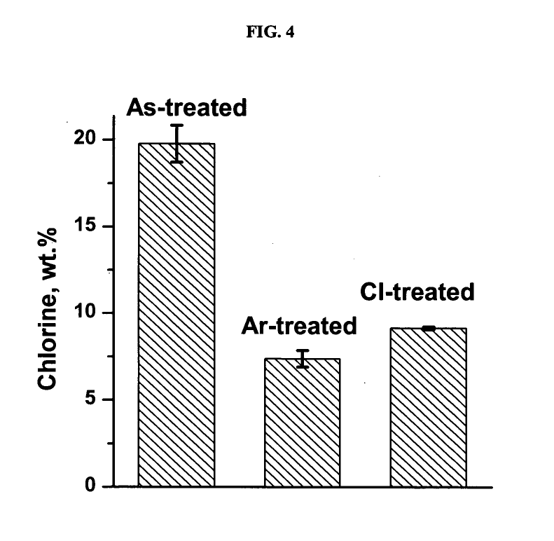

Finally, it was investigated whether the instant biocidal materials could be reloaded with chlorine after use. As a preliminary qualitative experiment, we dechlorinated material prepared from SiC containing about 20 weight percent chlorine by subsequent annealing in Ar at 800° C. A decrease in the content of chlorine to about seven weight percent was observed (FIG. 4). Subsequent heating in Cl₂ led to a minor (less than two weight percent) increase in chlorine content. Various types of carbon react with molecular chlorine, resulting in stable chlorine-carbon complexes. Boehm H P. Graphite and Precursors. In: Delhaes P, editor. Amsterdam: Gordon and Beach, at pp. 141-178 (2001); Puri B R. Chemistry and Physics of Carbon. In: Walker P L, editor. NY: Marcel Dekker, at pp. 191-282 (1970). Carbon blacks are chlorinated by treatment with Cl₂ at elevated temperatures. Boehm H P, Hofmann U, Clauss A. 1957. Pergamon Press, New York. The amount of chlorine bound was roughly equivalent to the initial hydrogen content of the carbon black before chlorination. This suggested substitution of hydrogen by chlorine. See Tobias H & Soffer A. Chemisorption of Halogen on Carbon-II. Thermal Reversibility of Cl₂ and H₂Chemisorption. Carbon 1985; 23:291; Tobias H & Soffer A. Chemisorption of Halogen on Carbon-I. Stepwise Chlorination and Exchange of C—Cl with C—H Bonds. Carbon 1985:281.

These results demonstrate that the chlorine must be loaded during the synthesis process. Furthermore, as contrasted with the instant materials, conventional activated carbon cannot be easily loaded with chlorine to achieve the bactericidal properties of the instant chlorine-loaded biocidal materials.

Living organisms, including bacteria such as B. anthracis spores and vegetative cells and E. coli, are effectively killed by chlorine released from the instant materials, even after one week of storing the materials in liquid solution. B. anthracis grown either in broth or on plates is killed equally well, and biocidal properties are reproducible from day to day, and from batch to batch of material. The present materials can store over 60 weight percent of chlorine, and can steadily supply small amounts of chlorine into water or air and maintain its biocidal properties for a much longer period of time than sodium hypochlorite (bleach). These properties make material loaded with chlorine a more efficient antimicrobial product than bleach, which initially releases a larger amount of chlorine into solution. Thus, the instant materials represent highly effective, efficient, and persistent biocidal compositions that can be applied to a very broad array of appropriate uses.

1. A biocidal material comprising a carbon having a plurality of pores, said pores having characteristic dimensions less than about 2 nm, the material further comprising releasable chlorine in the range from about 5 to about 70 weight percent relative to the weight of the entire material including chlorine, said releasable chlorine being bound to the material with an affinity such that even after more than one week exposure of the biocidal material to a liquid, the material retains and is subsequently able to release sufficient chlorine to kill bacteria.

2. The material according to claim 1 made from a binary or ternary carbide.

3. The material according to claim 2 wherein the carbide comprises SiC, TiC, ZrC, B₄C, WC, CaC₂, Al₄C₃, or Ti₃SiC₂.

4. The material according to claim 1, comprising a carbide reacting with chlorine at a temperature in the range of from about 200° C. to about 1200° C.

5. The material according to claim 4, wherein said temperature is in the range of from about 200° C. to about 800° C.

6. The material according to claim 1 comprising releasable chlorine in the range of from about 5 to about 60 weight percent, relative to the weight of the entire material including chlorine.

7. The material according to claim 1 comprising releasable chlorine in the range of from about 10 to about 60 weight percent, relative to the weight of the entire material including chlorine.

8. The material according to claim 1 comprising releasable chlorine in the range of from about 30 to about 60 weight percent, relative to the weight of the entire material including chlorine.

9. A biocidal system comprising: a material comprising a carbon having a plurality of pores, said pores having characteristic dimensions less than about 2 nm, the material further comprising releasable chlorine in the range of from about 5 to about 70 weight percent chlorine relative to the weight of the entire material including chlorine, said releasable chlorine being bound to the material with an affinity such that even after more than one week exposure of the chlorine-containing material to a liquid, the material retains and is able to release sufficient chlorine to effectively kill bacteria; and a container from receiving said material.

10. The biocidal system according to claim 9, said material having been made from a binary or ternary carbide.

11. The biocidal system according to claim 10, wherein said carbide comprises SiC, TiC, ZrC, B₄C, WC, CaC₂, Al₄C₃, or Ti₃SiC₂.

12. The biocidal system according to claim 9, said material comprising a carbide reacting with chlorine at a temperature in the range of from about 200° C. to about 1200° C.

13. The biocidal system according to claim 12, wherein said temperatures is in the range of from about 200° C. to about 800° C.

14. The biocidal system according to claim 9, said material comprising releasable chlorine in the range of from about 5 to about 70 weight percent, relative to the weight of the entire material including chlorine.

15. The biocidal system according to claim 9, said material comprising releasable chlorine in the range of from about 5 to about 60 weight percent, relative to the weight of the entire material including chlorine.

16. The biocidal system according to claim 9, said material comprising releasable chlorine in the range of from about 10 to about 60 weight percent, relative to the weight of the entire material including chlorine.

17. The biocidal system according to claim 9, said material comprising releasable chlorine in the range of releasable chlorine in the range of from about 30 to about 60 weight percent, relative to the weight of the entire material including chlorine.

18. The biocidal system according to claim 9, wherein said container comprises a cartridge, a pouch, a filter frame, a binder, a suspension matrix, or a fluid filtration unit.

19. A method for killing microorganisms present in a fluid, comprising contacting said fluid with a biocidal material of claim 1.

20. The method according to claim 19, said material having been made from a binary or ternary carbide.

21. The method according to claim 19, wherein said carbide comprises SiC, TiC, ZrC, B₄C, WC, CaC₂, Al₄C₃, or Ti₃SiC₂.

22. The method according to claim 19, said material comprising a carbide reacting with chlorine at a temperature in the range of from about 200° C. to about 1200° C.

23. The method according to claim 22, wherein said temperatures is in the range of from about 200° C. to about 800° C.

24. The method according to claim 19, said material comprising releasable chlorine in the range of from about 5 to about 70 weight percent, relative to the weight of the entire material including chlorine.

25. The method according to claim 19, said material comprising releasable chlorine in the range of from about 5 to about 60 weight percent, relative to the weight of the entire material including chlorine.

26. The method according to claim 19, said material comprising releasable chlorine in the range of from about 10 to about 60 weight percent, relative to the weight of the entire material including chlorine.

27. The method according to claim 19, said material comprising releasable chlorine in the range of from about 30 to about 60 weight percent, relative to the weight of the entire material including chlorine.

28. The method according to claim 19 wherein said fluid comprises gas.

29. The method according to claim 19 wherein said fluid comprises liquid.

30. The method according to claim 19 wherein said organisms comprise bacteria.

31. The method according to claim 30 wherein said bacteria comprises Bacillus anthracis or Escherichia coli.

32. The method according to claim 19 wherein said contacting has a duration of about 1 minute or longer.

33. The method according to claim 19 wherein said contacting has a duration of about 10 minutes or longer.

34. The method according to claim 19 wherein said contacting has a duration of about 30 minutes or longer.

35. The method according to claim 19 wherein said contacting has a duration of about 60 minutes or longer.

36-42. (canceled)

43. The material of claim 1 wherein said bacteria are air-borne or water-borne.

44. The material of claim 43 wherein said bacteria comprise Bacillus anthracis.

45. The material of claim 43 wherein said bacteria comprise Escherichia coli.

46. The system of claim 9 wherein the bacteria are air-borne or water-borne.

47. The system of claim 46 wherein said bacteria comprise Bacillus anthracis.

48. The system of claim 46 wherein said bacteria comprise Escherichia coli.
